(19) United States
(12) Patent Application Publication
(10) Pub. No.: US 2025/0077732 A1
(43) Pub. Date: Mar. 6, 2025

(54) HYBRID-EQUIVALENCE-BASED POWER ELECTRONICS SYSTEM PARTITION COMPUTING METHOD

(71) Applicant: SOUTHEAST UNIVERSITY, Nanjing, Jiangsu (CN)

(72) Inventors: Jianfeng ZHAO, Nanjing, Jiangsu (CN); Cheng JIN, Nanjing, Jiangsu (CN); Kangli LIU, Nanjing, Jiangsu (CN); Pengyu WANG, Nanjing, Jiangsu (CN); Wenzhe CHEN, Nanjing, Jiangsu (CN); Xirui GUO, Nanjing, Jiangsu (CN)

(21) Appl. No.: 18/552,092

(22) PCT Filed: Apr. 27, 2023
(86) PCT No.: PCT/CN2023/091065

§ 371 Date: Sep. 22, 2023

(30) Foreign Application Priority Data
Apr. 26, 2023 (CN) 202310461916.6

(51) Int. Cl. G06F 30/20; G06F 111/10; G06F 113/04

(52) U.S. Cl. CPC G06F 30/20; G06F 2111/10; G06F 2113/04

(57) ABSTRACT

The present invention discloses a hybrid-equivalence-based power electronics system partition computing method, and relates to the field of power electronics simulation. In the power electronics system partition computing method, by separating series nodes and parallel nodes from internal nodes, converting the series nodes into an impedance form, and converting the parallel nodes into an admittance form, hybrid equivalent conversion of sub-partitions is implemented. By projecting hybrid equivalent matrices and hybrid excitation matrices of the sub-partitions onto a global coupling coordinate system, there is linear additivity between the hybrid equivalent matrices of the sub-partitions, and a series coupling current and a parallel coupling voltage of a system are efficiently solved, thereby implementing parallel partition decoupling computing of the power electronics system.

### TECHNICAL FIELD

The present invention relates to the field of power electronics simulation, and specifically, to a hybrid-equivalence-based power electronics system partition computing method.

### BACKGROUND

With development of power electronics technologies, penetration of power electronics devices is increasingly high in power systems. A transient switching process of a power electronics device is complex. Therefore, when a power electronics system of a large-scale complex structure is simulated, if a conventional whole circuit simulation method is adopted, problems of a large model dimension and a low computing efficiency occur. A contradiction between the ever-increasing scale of the power electronics system and a limited processor computing power poses a challenge to large-scale power electronics simulation, while power electronics system partition computing is a method for effectively overcoming the increase in the power electronics scale. By splitting a whole circuit into several sub-circuits, distributed computation of a simulation process is implemented.

### SUMMARY

For a disadvantage of a low decoupling computing efficiency in an existing complex series and parallel power electronics system during circuit partitioning based on a Thevenin equivalent method, the present invention provides a hybrid-equivalence-based power electronics system partition computing method.

The objective of the present invention can be achieved by the following technical solution:

A hybrid-equivalence-based power electronics system partition computing method includes the following steps:

(1) Statistics are collected on a quantity s of series loops and a quantity p of parallel nodes in a simulation model according to a manual partitioning result or an automatic partitioning result of a simulation circuit, and each loop and each node are uniquely numbered, where the series loop refers to several partitions coupled together through a same series current, and the parallel node refers to several partitions coupled together through a same parallel node. A model coupling vector iu=[i₁ . . . iₛ, u₁ . . . uₚ] is obtained according to a statistical result, where i₁-iₛ are series loop currents, and u₁-uₚ are parallel node voltages.

(2) A node voltage equation of each sub-partition is established according to a partitioning result of the simulation model, where a quantity of nodes in a sub-partition j is n, a node voltage equation is established,

$${u}_{j} = {Z}_{j} ( {h}_{j} + {y}_{j} )$$

where uⱼ is a sub-partition n×1 node voltage vector, Zⱼ is a sub-partition n×n impedance matrix, hⱼ is an n×1 node current vector corresponding to the node voltage vector, yⱼ is a vector of an external coupling current injected into each node from a series loop and a parallel node outside a sub-partition and has a size of n×1, and a node into which no external coupling current is injected is filled with 0 in yᵢ.

(3) A permutation matrix Sⱼ and an inverse matrix S⁻¹ⱼ of the permutation matrix are obtained according to a relationship between an internal node of the sub-partition j and a series loop and a parallel node in the simulation model, and separation of the internal node of the sub-partition, a series coupling node, and a parallel coupling node is implemented. The separation process obeys the following order, the internal node vector of the sub-partition j is nⱼ=[n₁, n₂ . . . , nₘ]^{T}, and a classified node vector n_{cj}=[nᵣ₁ . . . nᵣⱼ, nₛ₁ . . . nₛⱼ, nₚ₁ . . . nₚⱼ]^{T} is obtained by adjusting an order of elements in the node vector, where nᵣ₁-nᵣⱼ are internal nodes in the sub-partition j that are not connected to other partitions, and a quantity of the internal nodes is rⱼ; nₛ₁-nₛⱼ are nodes in the sub-partition j that are connected in series in the series loop of the simulation model, and a quantity of the series nodes is sⱼ; and nₚ₁-nₚⱼ are nodes in the sub-partition j that are connected in parallel on the parallel node of the simulation model, and a quantity of the nodes is pⱼ. Generally, there are several manners of constructing the classified node vector. As long as a vector satisfies aggregation characteristics of an internal node, a series node, and a parallel node in the classified node vector, the vector may be selected as a valid classified node vector. It is defined that the permutation matrix Sⱼ satisfies a definition Sⱼ×nⱼ=n_{cj}, and the permutation matrix Sⱼ and the inverse matrix S⁻¹ⱼ of the permutation matrix=(Sⱼ)⁻¹ are computed according to nⱼ and n_{cj}.

(4) Classification conversion is performed according to the node voltage equation in the sub-partition j and the permutation matrix Sⱼ, where the node current vector hⱼ is subject to classification conversion of the permutation matrix Sⱼ, to obtain a classified node current vector:

$${S}_{j} {h}_{j} = [ \begin{matrix}{h}_{r j} \\ {h}_{s j} \\ {h}_{p j}\end{matrix} ]$$

and the sub-partition impedance matrix Zⱼ is subject to classification conversion, to obtain a classified partition impedance matrix SⱼZⱼS⁻¹ⱼ:

$${S}_{j} {Z}_{j} {S}_{j}^{- 1} = [ \begin{matrix}{SZS}_{j}^{1} & {SZS}_{j}^{2} & {SZS}_{j}^{3} \\ {SZS}_{j}^{4} & {SZS}_{j}^{5} & {SZS}_{j}^{6} \\ {SZS}_{j}^{7} & {SZS}_{j}^{8} & {SZS}_{j}^{9}\end{matrix} ]$$

where SZS¹ⱼ has a matrix size of rⱼ×rⱼ, SZS²ⱼ has a matrix size of rⱼ×sⱼ, SZS³ⱼ has a matrix size of rⱼ×pⱼ, SZS⁴ⱼ has a matrix size of sⱼ×rⱼ, SZS⁵ⱼ has a matrix size of sⱼ×sⱼ, SZS⁶ⱼ has a matrix size of sⱼ×pⱼ, SZS⁷ⱼ has a matrix size of pⱼ×rⱼ, SZS⁸ⱼ has a matrix size of pⱼ×sⱼ, and SZS⁹ⱼ has a matrix size of pⱼ×pⱼ.

(5) Hybrid equivalent conversion is performed according to results of the current vector classification conversion Sⱼhⱼ in the sub-partition j and the impedance matrix classified partition conversion SⱼZⱼS⁻¹ⱼ, where the hybrid equivalent conversion includes conversion of a hybrid excitation matrix Bⱼ, conversion of a hybrid voltage vector eⱼ, and conversion of a hybrid equivalent matrix Gⱼ.

The hybrid excitation matrix Bⱼ has a matrix size of (sⱼ+pⱼ)×(sⱼ+pⱼ), and satisfies conversion:

$${B}_{j} = [ \begin{matrix}{B}_{j}^{1} & {B}_{j}^{2} \\ {B}_{j}^{3} & {B}_{j}^{4}\end{matrix} ] = [ \begin{matrix}E & - {{SZS}_{j}^{6} ( {SZS}_{j}^{9} )}^{- 1} \\ O & - {( {SZS}_{j}^{9} )}^{- 1}\end{matrix} ]$$

where B¹ⱼ is an identity matrix whose size is sⱼ×sⱼ, B²ⱼ is a matrix whose size is sⱼ×pⱼ, B³ⱼ is an all-0 matrix whose size is pⱼ×sⱼ, and B⁴ⱼ is a matrix whose size is pⱼ×pⱼ.

The hybrid voltage vector eⱼ satisfies conversion:

$${e}_{j} = [ \begin{matrix}{e}_{s j} \\ {e}_{p j}\end{matrix} ] = [ \begin{matrix}{SZS}_{j}^{4} & {SZS}_{j}^{5} & {SZS}_{j}^{6} \\ {SZS}_{j}^{7} & {SZS}_{j}^{8} & {SZS}_{j}^{9}\end{matrix} ] [ \begin{matrix}{h}_{r j} \\ {h}_{s j} \\ {h}_{p j}\end{matrix} ]$$

where eₛⱼ has a vector size of sⱼ×1, and eₚⱼ has a vector size of pⱼ×1.

The hybrid equivalent matrix satisfies conversion:

$${G}_{j} = [ \begin{matrix}{G}_{j}^{1} & {G}_{j}^{2} \\ {G}_{j}^{3} & {G}_{j}^{4}\end{matrix} ] [ \begin{matrix}{SZS}_{j}^{5} - {SZS}_{j}^{6} {( {SZS}_{j}^{9} )}^{- 1} {SZS}_{j}^{8} & {SZS}_{j}^{6} {( {SZS}_{j}^{9} )}^{- 1} \\ - {( {SZS}_{j}^{9} )}^{- 1} {SZS}_{j}^{8} & {( {SZS}_{j}^{9} )}^{- 1}\end{matrix} ]$$

where G¹ⱼ has a size of sⱼ×sⱼ, G²ⱼ has a size of sⱼ×pⱼ, G³ⱼ has a size of pⱼ×sⱼ, and G⁴ⱼ has a size of pⱼ×pⱼ.

(6) A coupling mapping matrix Mⱼ is obtained according to the classified node vector n_{cj} of the sub-partition j and an injection relationship between a series current and a parallel current of the model coupling vector iu, where the coupling mapping matrix has a matrix size of (s+p)×(sⱼ+pⱼ) and a structure of

$${M}_{j} = [ \begin{matrix}{P}_{j} & O \\ O & {Q}_{j}\end{matrix} ]$$

Pⱼ is a series interface coupling matrix, has a matrix size of s×sⱼ, where k∈[1, s] and l∈[1, sⱼ], and satisfies a definition:

$${P}_{j} ( k , l ) = \{ \begin{matrix}1 & If the {k}^{th} series current of iu flows into the node l in the sub - partition j \\ - 1 & If the {k}^{th} series current of iu flows out of the node l in the sub - partition j \\ 0 & If the {k}^{th} series current of iu is not connected to the node l in the sub - partition j\end{matrix}$$

Qⱼ is a parallel interface coupling matrix, has a matrix size of p×pⱼ, where k∈[1, p] and l∈[1,pⱼ], and satisfies a definition:

$${Q}_{j} ( k , l ) = \{ \begin{matrix}1 & If the {k}^{th} parallel voltage of iu is connected to the node l in the sub - partition j \\ 0 & If the {k}^{th} parallel voltage of iu is not connected to the node l in the sub - partition j\end{matrix}$$

O is an all-0 matrix of a corresponding size.

(7) The model coupling vector iu is computed according to the coupling mapping matrix Mⱼ of each sub-partition, the hybrid excitation matrix Bⱼ, the hybrid voltage vector eⱼ, and the hybrid equivalent matrix Gⱼ. A formula for computing the coupling vector iu is:

$$iu = - {( \sum {M}_{j} {G}_{j} {M}_{j}^{T} )}^{- 1} ( \sum {M}_{j} {B}_{j} {e}_{j} )$$

where the summation symbol refers to computing of a sum of elements corresponding to all sub-partitions in the model.

(8) A node voltage in the sub-partition j is computed according to the model coupling vector iu, and a node voltage vector uⱼ in the partition is computed according to the node voltage equation of each sub-partition in step (1), the inverse matrix S⁻¹ⱼ of the permutation matrix in step (3), and the model coupling vector iu in step (7), where a formula for computing uⱼ is:

$${u}_{j} = {Z}_{j} [ {h}_{j} + {S}_{j}^{1} ( [ \begin{matrix}O & O \\ O & O \\ {B}_{j}^{3} & {B}_{j}^{4}\end{matrix} ] [ \begin{matrix}{e}_{sj} \\ {e}_{pj}\end{matrix} ] + [ \begin{matrix}O & O \\ E & O \\ {G}_{j}^{3} & {G}_{j}^{4}\end{matrix} ] {M}_{j}^{T} \times iu ) ]$$

The external coupling term iu required for computing each sub-partition has been computed in step (7), and decoupling between the partition circuit and the model is implemented. Therefore, in this step, computing processes of node voltages of sub-partitions are independent of each other, the computing processes have parallel and distributed characteristics, and simulation efficiency is significantly improved compared with a centralized computing process.

The advantageous effects of the present invention are as follows:

In the present invention, a one-to-one relationship between neighboring partitions in a conventional partition algorithm is improved into a many-to-many relationship between a series coupling current and a parallel coupling voltage, to solve a problem that a computing amount of connecting voltages and currents between partitions are significantly increased when a quantity of partitions of a large-scale power electronics system is quickly increased. In the present invention, a series node and a parallel node of a sub-partition are separated from internal nodes of the sub-partition, to avoid invalid computing in a decoupling process and improve model decoupling solving efficiency. In the present invention, through hybrid equivalent conversion, a series port is converted into an impedance form, and a parallel port is converted into an admittance form, so that linear superposition of hybrid equivalent matrices mapped under any parallel-series connection structure may be implemented. In the present invention, through a series coupling current and a parallel coupling voltage between partitions, partition decoupling is implemented, and parallel computing and distributed computation of the model are implemented.

### BRIEF DESCRIPTION OF THE DRAWINGS

The following further describes the present invention in detail with reference to the accompanying drawings.

FIG. 1 is a schematic diagram of describing a principle of a typical application scenario based on an input-parallel-output-series converter according to the present invention;

FIG. 2 is a schematic diagram of a separation process of an internal node of a sub-partition, a series coupling node, and a parallel coupling node according to the present invention;

FIG. 3 is a schematic diagram of hybrid equivalent conversion according to the present invention;

FIG. 4 is a diagram of a principle of computing a system coupling vector based on the Kirchhoff s current law (KCL) and the Kirchhoff's voltage law (KVL) according to the present invention; and

FIG. 5 is a schematic diagram of a principle of implementing distributed parallel computing according to the present invention.

### DETAILED DESCRIPTION

The following clearly and completely describes the technical solutions in the embodiments with reference to the accompanying drawings in the embodiments. Apparently, the described embodiments are merely some but not all of the embodiments of the present invention. Based on the embodiments of the present invention, all other embodiments obtained by a person of ordinary skill in the art without creative efforts shall fall within the protection scope of the present invention.

In the descriptions of this specification, descriptions using reference terms such as “an embodiment”, “an example”, or “a specific example” mean that specific characteristics, structures, materials, or features described with reference to the embodiment or example are included in at least one embodiment or example of the present invention. In this specification, schematic descriptions of the foregoing terms do not necessarily point at a same embodiment or example. Moreover, the specific features, structures, materials, or characteristics described may be combined in any one or more embodiments or examples in an appropriate manner.

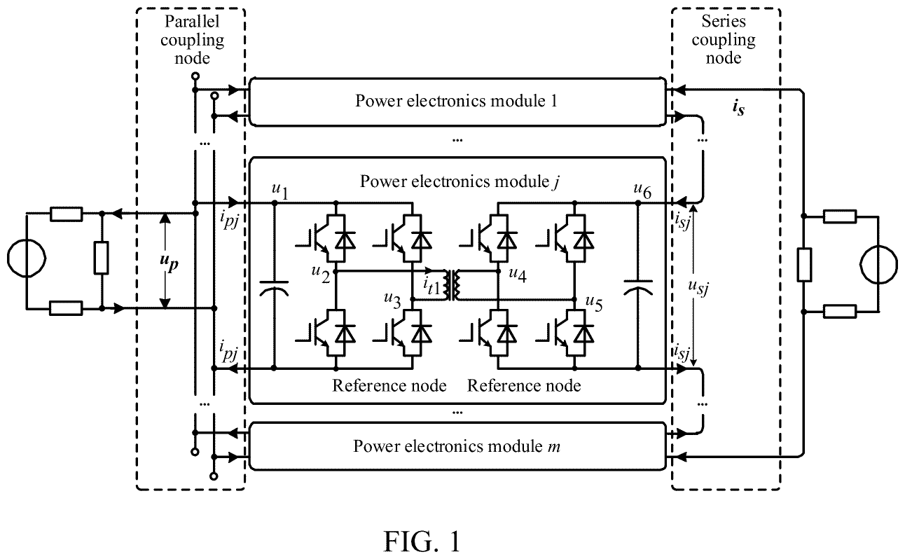

The present invention relates to a hybrid-equivalence-based power electronics system partition computing method. The power electronics system partition computing method in the present invention implements, based on the series and parallel coupling relationship between power electronics partitions, partition decoupling computing that is shown in FIG. 1 and that has a complex series and parallel topology. Based on a characteristic that impedances can be linearly superposed in the series coupling loop and the Kirchhoff's voltage law, as well as a characteristic that admittances on the parallel coupling node can be linearly superposed and the Kirchhoff s current law, the present invention provides hybrid equivalent conversion containing both series impedances and parallel admittances, implements linear superposition and solving of series coupling currents and parallel coupling voltages in a model, and changes the increase in matrix dimension to the superposition of smaller matrices; and implements independent parallel computing of sub-partitions based on decoupling between the series coupling current and the parallel coupling voltage.

Compared with other types of power systems, the power electronics system has a problem that the topological structure of the circuit is complex, and a plurality of series and parallel structures may exist in a same partition. As shown in an input-parallel-output-series converter in FIG. 1, each power electronics module is treated as a partition, all sub-partitions on a parallel side of the converter and other sub-partitions are connected together in parallel, while all sub-partitions on a series side of the converter and other sub-partitions are connected together in series. If a conventional Thevenin equivalent method with a 1:1 partition relationship is adopted, because there are a large quantity of sub-partitions, there are also a large quantity of equations established to describe a relationship between partitions, and there is a problem of low efficiency of solving a coupling relationship if large-scale power electronics model simulation is performed. To solve this problem, the present invention provides a hybrid-equivalence-based power electronics system partition computing method, and an n:n sub-partition relationship model whose theoretical basis is the Kirchhoff's voltage law and linear superposition of loop impedances, as well as the Kirchhoff's current law and linear superposition of parallel admittances. That is to say, a series loop current of a plurality of partitions connected in series and a parallel node voltage of a plurality of partitions connected in parallel are first solved.

The power electronics system partition computing method described in the present invention includes eight parts:

(1) collecting statistics on series and parallel coupling of a simulation model; (2) establishing a node voltage equation of a sub-partition; (3) constructing a permutation matrix Sⱼ to separate an internal node of the sub-partition, series node, and parallel node; (4) performing classification conversion on the node current vector Sⱼhⱼ, and performing classified partition conversion on the node impedance matrix SⱼZⱼS⁻¹ⱼ; (5) converting the hybrid excitation matrix Bⱼ, the hybrid voltage vector eⱼ, and the hybrid equivalent matrix Gⱼ; (6) constructing the coupling mapping matrix Mⱼ (7) computing a coupling vector iu; and (8) computing the node voltage of the sub-partition.

The eight parts are described in detail below with reference to the accompanying drawings.

In the step of collecting statistics on the series coupling loop and the parallel coupling node of the simulation model, in the present invention, statistics are collected on a quantity s of series loops and a quantity p of parallel nodes in a simulation model according to a manual partitioning result or an automatic partitioning result of a simulation circuit, to obtain a model coupling vector iu=[i₁ . . . iₛ, u₁ . . . uₚ], where i₁-iₛ are series loop currents, and u₁-uₚ are parallel node voltages. For example, in FIG. 1, such two coupling variables as a series coupling current is and a parallel coupling node voltage uₚ and a coupling vector [iₛ, uₚ] are obtained according to the manual partitioning result.

A node voltage equation of each sub-partition is established. Taking a power electronics module sub-partition j in FIG. 1 as an example, a total quantity of nodes containing additional nodes such as a voltage source, a controlled voltage source, and a transformer in the sub-partition j is n, and a node voltage equation is established:

$$[ \begin{matrix}{u}_{1} \\ ⋮ \\ {u}_{6} \\ 0\end{matrix} ] = [ \begin{matrix}{𝓏}_{11} & ⋯ & {𝓏}_{16} & {𝓏}_{17} \\ ⋮ & ⋱ & ⋮ & ⋮ \\ {𝓏}_{61} & ⋯ & {𝓏}_{66} & {𝓏}_{67} \\ {𝓏}_{71} & ⋯ & {𝓏}_{76} & {𝓏}_{77}\end{matrix} ] [ \begin{matrix}{h}_{1} + {i}_{pj} \\ ⋮ \\ {h}_{6} + {i}_{sj} \\ {i}_{t 1}\end{matrix} ]$$

where uⱼ is a sub-partition n×1 node voltage vector, Zⱼ is a sub-partition n×n impedance matrix, hⱼ is an n×1 node current vector corresponding to the node voltage vector, yⱼ is a vector of an external coupling node current injected into each node from a series loop and a parallel node outside a sub-partition and is a vector that contains iₚⱼ and uₚⱼ and has a size of n×1 in FIG. 1, and a node into which no external coupling current is injected is filled with 0 in yᵢ. The established node voltage equation may be written as a general node voltage form:

$${u}_{j} = {Z}_{j} ( {h}_{j} + {y}_{j} )$$

According to whether voltages of nodes in the sub-partition j are associated with the model coupling vector iu, nodes nⱼ=[n₁, n₂ . . . , nₘ]^{T} in the sub-partition j are divided into three types that are respectively: (1) internal nodes, not connected to other partitions; (2) series nodes, connected in series in the series coupling loop of the model; and (3) parallel nodes, connected in parallel on the parallel coupling node of the model. The three types of nodes form classified node vectors n_{cj}=[nᵣ₁ . . . nᵣⱼ, nₛ₁ . . . nₛⱼ, nₚ₁ . . . nₚⱼ]^{T} in a type aggregation order, where nᵣ₁-nᵣⱼ are internal nodes in the sub-partition j that are not connected to other partitions, and a quantity of the internal nodes is rⱼ; nₛ₁-nₛⱼ are nodes in the sub-partition j that are connected in series in the series loop of the simulation model, and a quantity of the series nodes is sⱼ; and nₚ₁-nₚⱼ are nodes in the sub-partition j that are connected in parallel on the parallel node of the simulation model, and a quantity of the nodes is pⱼ. The classified node vector is not unique, and any vector order conforming to the foregoing three types of aggregation constraints may be treated as the classified node vector n_{cj}. According to an original node vector nⱼ and a classified node vector n_{cj} whose element order is changed, a permutation matrix Sⱼ from the original node vector to the classified node vector may be obtained, and the permutation matrix Sⱼ satisfies the following constraint:

$${S}_{j} \times {n}_{j} = {n}_{cj}$$

The permutation matrix Sⱼ is an n×n orthogonal matrix, there is one and only one element of 1 in each row and each column of Sⱼ, and all other elements are 0. The position of the element of 1 in each row determines the node in nⱼ which is placed into the corresponding row of n_{cj}, and the node order in the node voltage equation of the sub-partition j may be changed through the permutation matrix Sⱼ. After Sⱼ is obtained through computing, the following inverse matrix S⁻¹ⱼ thereof is obtained through computing:

Sⱼ⁻¹=(Sⱼ)⁻¹

After being obtained, Sⱼ is used to convert the node voltage uⱼ, to obtain the following classified node voltage vector:

$${S}_{j} {u}_{j} = [ \begin{matrix}{u}_{rj} \\ {u}_{sj} \\ {u}_{pj}\end{matrix} ]$$

where uᵣⱼ is a voltage vector of the internal nodes of the sub-partition j and has a vector size of rⱼ×1, uₛⱼ is a voltage vector of the series nodes in the sub-partition j and has a vector size of sⱼ×1, and uₚⱼ is a voltage vector of the parallel nodes and has a vector size of pⱼ×1.

The node current hⱼ is converted, to obtain the following classified node current vector:

$${S}_{j} {h}_{j} = [ \begin{matrix}{h}_{rj} \\ {h}_{sj} \\ {h}_{pj}\end{matrix} ]$$

where hᵣⱼ is a current vector of an internal node of the sub-partition j and has a vector size of rⱼ×1, hₛⱼ is an internal injection current vector of a series node of the sub-partition j and has a vector size of sⱼ×1, and hₚⱼ is an internal current vector of a parallel node of the sub-partition j and has a vector size of pⱼ×1.

In addition, the coupling injection current yⱼ is converted, to obtain the following external series and parallel coupling injection current vector:

$${S}_{j} {y}_{j} = [ \begin{matrix}O \\ {i}_{sj} \\ {i}_{pj}\end{matrix} ]$$

where O is an all-0 vector and has a vector size of rⱼ×1, iₛⱼ is an internal injection current vector of the series nodes of the sub-partition and has a vector size of sⱼ×1, and iₚⱼ is an internal current vector of the parallel nodes of the sub-partition and has a vector size of pⱼ×1.

The node voltage impedance matrix is subject to SⱼZⱼS⁻¹ⱼ conversion, to obtain a classified partition impedance matrix SⱼZⱼS⁻¹ⱼ of the sub-partition, which satisfies the following form:

$${S}_{j} {Z}_{j} {S}_{j}^{- 1} = [ \begin{matrix}{SZS}_{j}^{1} & {SZS}_{j}^{2} & {SZS}_{j}^{3} \\ {SZS}_{j}^{4} & {SZS}_{j}^{5} & {SZS}_{j}^{6} \\ {SZS}_{j}^{7} & {SZS}_{j}^{8} & {SZS}_{j}^{9}\end{matrix} ]$$

where SZS¹ⱼ has a matrix size of rⱼ×rⱼ, SZS²ⱼ has a matrix size of rⱼ×sⱼ, SZS³ⱼ has a matrix size of rⱼ×pⱼ, SZS⁴ⱼ has a matrix size of sⱼ×rⱼ, SZS⁵ⱼ has a matrix size of sⱼ×sⱼ, SZS⁶ⱼ has a matrix size of sⱼ×pⱼ, SZS⁷ⱼ has a matrix size of pⱼ×rⱼ, SZS⁸ⱼ has a matrix size of pⱼ×sⱼ, and SZS⁹ⱼ has a matrix size of pⱼ×pⱼ. For the classified partition matrix, according to the quantity rⱼ of the internal nodes, the quantity sⱼ of the series nodes, and the quantity pⱼ of the parallel nodes of the sub-partition j, and according to the structure of the partition matrix whose size is (rⱼ+sⱼ+pⱼ)×(rⱼ+sⱼ+pⱼ), the original impedance matrix is subject to order permutation, and is divided into function blocks.

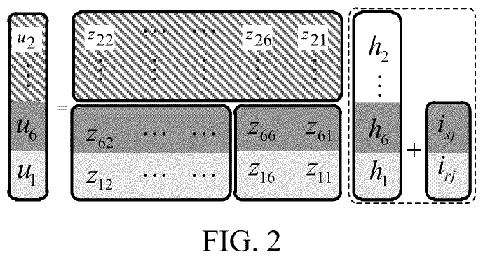

The sub-partition j shown in FIG. 1 is converted to obtain a classified node voltage model shown in FIG. 2.

After the classified partition impedance matrix SⱼZⱼS⁻¹ⱼ of the sub-partition j is obtained, conversion of the hybrid excitation matrix Bⱼ and conversion of the hybrid voltage vector eⱼ are performed, where the conversion of the hybrid excitation matrix Bⱼ is:

$${B}_{j} = [ \begin{matrix}{B}_{j}^{1} & {B}_{j}^{2} \\ {B}_{j}^{3} & {B}_{j}^{4}\end{matrix} ] = [ \begin{matrix}E & - {SZS}_{j}^{6} {( {SZS}_{j}^{9} )}^{- 1} \\ O & - {( {SZS}_{j}^{9} )}^{- 1}\end{matrix} ]$$

where B¹ⱼ has a size of sⱼ×sⱼ is an identity matrix, B²ⱼ has a size of sⱼ×pⱼ, B³ⱼ has a size of pⱼ×sⱼ and is an all-0 matrix, and B⁴ⱼ has a size of pⱼ×pⱼ.

The conversion of the hybrid voltage vector eⱼ satisfies the following definition:

$${e}_{j} = [ \begin{matrix}{e}_{sj} \\ {e}_{pj}\end{matrix} ] = [ \begin{matrix}{SZS}_{j}^{4} & {SZS}_{j}^{5} & {SZS}_{j}^{6} \\ {SZS}_{j}^{7} & {SZS}_{j}^{8} & {SZS}_{j}^{9}\end{matrix} ] [ \begin{matrix}{h}_{rj} \\ {h}_{sj} \\ {h}_{pj}\end{matrix} ]$$

where eₛⱼ has a vector size of sⱼ×1, and eₚⱼ has a vector size of pⱼ×1. After being subject to the conversion of the hybrid matrix Bⱼ, the hybrid voltage vector eⱼ of the series and parallel ports becomes voltage excitation in the series loop and current excitation in the parallel loop.

After the classified partition impedance matrix SⱼZⱼS⁻¹ⱼ of the sub-partition j is obtained, a hybrid equivalent matrix of the sub-partition j is computed, and satisfies the following conversion:

$${G}_{j} = [ \begin{matrix}{G}_{j}^{1} & {G}_{j}^{2} \\ {G}_{j}^{3} & {G}_{j}^{4}\end{matrix} ] [ \begin{matrix}{SZS}_{j}^{5} - {SZS}_{j}^{6} {( {SZS}_{j}^{9} )}^{- 1} {SZS}_{j}^{8} & {SZS}_{j}^{6} {( {SZS}_{j}^{9} )}^{- 1} \\ - {( {SZS}_{j}^{9} )}^{- 1} {SZS}_{j}^{8} & {( {SZS}_{j}^{9} )}^{- 1}\end{matrix} ]$$

where G¹ⱼ has a size of sⱼ×sⱼ, G²ⱼ has a size of sⱼ×pⱼ, G³ⱼ has a size of pⱼ×sⱼ, and G⁴ⱼ has a size of pⱼ×pⱼ.

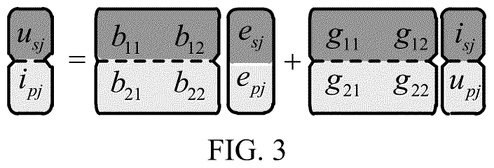

After being subjected to the hybrid equivalent conversion, the sub-partition satisfies a relationship shown in FIG. 3 and the following formula:

$$[ \begin{matrix}{u}_{s j} \\ {i}_{p j}\end{matrix} ] = [ \begin{matrix}{B}_{j}^{1} & {B}_{j}^{2} \\ {B}_{j}^{3} & {B}_{j}^{4}\end{matrix} ] [ \begin{matrix}{e}_{s j} \\ {e}_{p j}\end{matrix} ] + [ \begin{matrix}{G}_{j}^{1} & {G}_{j}^{2} \\ {G}_{j}^{3} & {G}_{j}^{4}\end{matrix} ] [ \begin{matrix}{i}_{s j} \\ {u}_{p j}\end{matrix} ]$$

In FIG. 3, the upper half part is to describe a relationship between the sub-partition j and the series loop in the coupling vector iu, where iₛⱼ is mapping of the series coupling loop current in the sub-partition j, and uₛⱼ is a port voltage of the sub-partition in the series loop. The lower half part is to describe a relationship between the sub-partition j and the parallel node in the coupling vector iu, where uₚⱼ is mapping of the parallel node voltage in the sub-partition j, and iₚⱼ is a port voltage of the sub-partition on the parallel node.

Further, to describe a relationship between the series current iₛⱼ, the series voltage uₛⱼ, the parallel voltage uₚⱼ, and the parallel current iₚⱼ of the sub-partition and the global coupling vector iu, a coupling mapping matrix Mⱼ of the sub-partition j is defined in the present invention, and has a matrix size of (s+p)×(sⱼ+pⱼ) and a structure of:

$${M}_{j} = [ \begin{matrix}{P}_{j} & O \\ O & {Q}_{j}\end{matrix} ]$$

Pⱼ is a series interface coupling matrix, has a matrix size of s×sⱼ, where k∈[1, s] and l∈[1, sⱼ], and satisfies a definition:

$${P}_{j} ( k , l ) = \{ \begin{matrix}1 & If the {k}^{th} series current of iu flows into the node l in the sub - partition j \\ - 1 & If the {k}^{th} series current of iu flows out of the node l in the sub - partition j \\ 0 & If the {k}^{th} series current of iu flows is not connected to the node l in the sub - partition j\end{matrix}$$

Qⱼ is a parallel interface coupling matrix, has a matrix size of p×pⱼ, where k∈[1, p] and l∈[1,pⱼ], and satisfies a definition:

$${Q}_{j} ( k , l ) = \{ \begin{matrix}1 & If the {k}^{th} parallel voltage of iu is connected to the node l in the sub - partition j \\ 0 & If the {k}^{th} parallel voltage of iu is not connected to the node l in the sub - partition j\end{matrix}$$

O is an all-0 matrix of a corresponding size.

The coupling mapping matrix Mⱼ defined in the present invention has two functions: (1) mapping the series loop current and the parallel node voltage in the global coupling vector iu into the sub-partition j through M^{T}ⱼ×iu; and (2) mapping the series port voltage in the sub-partition j into the global series loop through Pⱼ×uₛⱼ, and mapping the parallel node current in the sub-partition j into the global parallel node through Qⱼ×iₚⱼ.

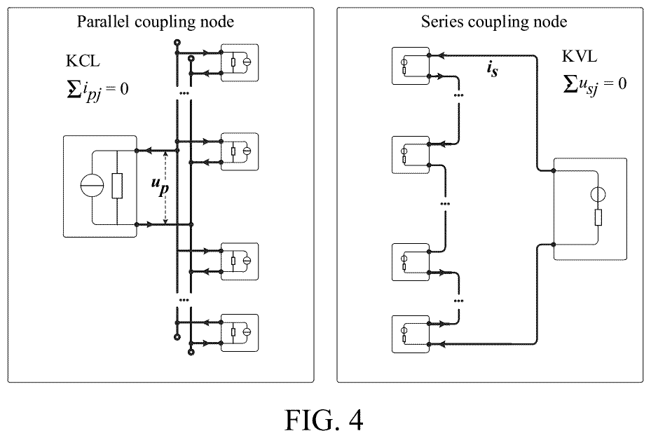

As shown in the right diagram of FIG. 4, it can be learned according to the Kirchhoff's voltage law (Kirchhoff s Voltage Law, KVL) in the series loop that a sum of voltages in the series loop is 0. As shown in the left diagram of FIG. 4, it can be learned according to the Kirchhoff s current law (Kirchhoff s Current Law, KCL) in the parallel loop that a sum of all currents on the parallel nodes is 0. It can be learned according to the principle that a formula for computing the coupling vector iu is:

$$i u = - {( \sum {M}_{j} {G}_{j} {M}_{j}^{T} )}^{- 1} ( \sum {M}_{j} {B}_{j} {e}_{j} )$$

That is to say, MⱼGⱼM^{T}ⱼ computed in all the partitions is added, MⱼBⱼeⱼ computed in all the partitions is added, and then the coupling vector iu is computed according to the foregoing formula.

After being obtained, the coupling vector iu is substituted into the sub-partition j to compute the node voltage uⱼ, and a formula for computing uⱼ is:

$${u}_{j} = {Z}_{j} [ {h}_{j} + {S}_{j}^{1} ( [ \begin{matrix}O & O \\ O & O \\ {B}_{j}^{3} & {B}_{j}^{4}\end{matrix} ] [ \begin{matrix}{e}_{s j} \\ {e}_{p j}\end{matrix} ] + [ \begin{matrix}O & O \\ E & O \\ {G}_{j}^{3} & {G}_{j}^{4}\end{matrix} ] {M}_{j}^{T} \times i u ) ]$$

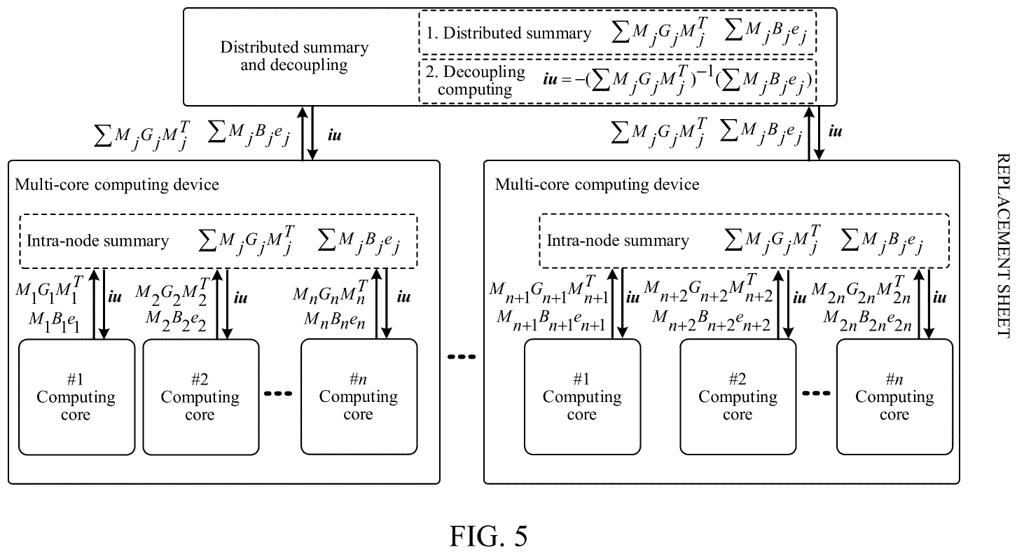

In the step of computing the coupling vector iu and the sub-partition node voltage uⱼ, processes of computing MⱼGⱼM^{T}ⱼ, MⱼBⱼeⱼ, and uⱼ of each sub-partition are independent of each other, and may be performed in parallel. Data needs to be exchanged between partitions only in the step of summation, the step of computing ΣMⱼGⱼM^{T}ⱼ and ΣMⱼBⱼeⱼ, the step of inversion of (ΣMⱼGⱼM^{T}ⱼ)⁻¹, and the step of finally computing a product of −(ΣMⱼGⱼM^{T}ⱼ)⁻¹(ΣMⱼBⱼeⱼ), and independent computing may be performed in all other steps. As shown in FIG. 5, the partition computing method provided in the present invention has distributed and parallel characteristics. On different cores of different nodes in a distributed system, MⱼGⱼM^{T}ⱼ and MⱼBⱼeⱼ of different parts of the model are respectively computed, then parallel summation is synchronized in the nodes, summation, inversion, and solving of iu are performed between distributed nodes, and finally a result of iu is synchronized into each computing core in the distributed system, to implement distributed computation of the model.

The basic principles, main features, and advantages of the present invention are shown and described above. A person skilled in the art should understand that the present invention is not limited by the foregoing embodiments. The foregoing embodiments and the descriptions of the specification merely explain principals of the present invention. Various variations and improvements of the present invention can be made without departing from the spirit and scope of the present invention, and the variations and improvements fall within the protection scope of the present invention.

What is claimed is:

1. A hybrid-equivalence-based power electronics system partition computing method, comprising:
collecting statistics on a quantity of series loops and a quantity of parallel nodes in a simulation model according to a manual partitioning result or an automatic partitioning result of a simulation circuit, to obtain a model coupling vector;
establishing a node voltage equation of each sub-partition according to a partitioning result of the simulation model;
obtaining a permutation matrix and an inverse matrix of the permutation matrix according to a coupling relationship between an internal node of the sub-partition and a series loop and a parallel node in the simulation model, and implementing aggregation and separation of the internal node of the sub-partition, a series coupling node, and a parallel coupling node;
performing classification conversion on the node voltage equation of the sub-partition according to a node voltage equation in the sub-partition and the permutation matrix, to obtain a classified node current vector and a classified partition impedance matrix;
performing hybrid equivalent conversion on a hybrid excitation matrix, a hybrid voltage vector, and a hybrid equivalent matrix based on the classified node current vector and the classified partition impedance matrix;
obtaining a coupling mapping matrix according to a sub-partition node and an injection relationship between a series loop current and a parallel node current of the model coupling vector;
computing the model coupling vector according to the coupling mapping matrix of each sub-partition, the hybrid excitation matrix, the hybrid voltage vector, and the hybrid equivalent matrix; and
computing a node voltage in each sub-partition according to the model coupling vector.

2. The hybrid-equivalence-based power electronics system partition computing method according to claim 1, wherein statistics are collected on the quantity s of series loops and the quantity p of parallel nodes in the simulation model according to the manual partitioning result or the automatic partitioning result of the simulation circuit, and numbering is performed; and
arranging all inter-partition series coupling loop currents and inter-partition parallel coupling voltages into a model coupling vector iu=[i₁ . . . iₛ, u₁ . . . uₚ], wherein i₁-iₛ are series loop currents, and u₁-uₚ are parallel node voltages.

3. The hybrid-equivalence-based power electronics system partition computing method according to claim 1, wherein the node voltage equation is uⱼ=Zⱼ(hⱼ+yⱼ),
wherein j represents a sub-partition, uⱼ is a sub-partition n×1 node voltage vector, Zⱼ is a sub-partition n×n impedance matrix, hⱼ is an n×1 node current vector corresponding to the node voltage vector, yⱼ is a vector of an external coupling current injected into each node from a series loop and a parallel node outside a sub-partition and has a size of n×1, and a node into which no external coupling current is injected is filled with 0 in yᵢ.

4. The hybrid-equivalence-based power electronics system partition computing method according to claim 3, wherein the permutation matrix Sⱼ satisfies a definition Sⱼ×nⱼ=n_{cj}, and the inverse matrix S⁻¹ⱼ of the permutation matrix=(Sⱼ)⁻¹,
wherein nⱼ is an internal node vector of the sub-partition j, and n_{cj} is a classified node vector obtained by adjusting an order of elements in the node vector.

5. The hybrid-equivalence-based power electronics system partition computing method according to claim 4, wherein
the classified node current vector Sⱼhⱼ satisfies:
$${S}_{j} {h}_{j} = [ \begin{matrix}{h}_{r j} \\ {h}_{s j} \\ {h}_{p j}\end{matrix} ] ,$$
wherein hᵣⱼ is a current vector of an internal node of the sub-partition j and has a vector size of rⱼ×1, hₛⱼ is an internal injection current vector of a series node of the sub-partition j and has a vector size of sⱼ×1, and hₚⱼ is an internal current vector of a parallel node of the sub-partition j and has a vector size of pⱼ×1; and
the classified partition impedance matrix SⱼZⱼS⁻¹ⱼ satisfies:
$${S}_{j} {Z}_{j} {S}_{j}^{- 1} = [ \begin{matrix}{SZS}_{j}^{1} & {SZS}_{j}^{2} & {SZS}_{j}^{3} \\ {SZS}_{j}^{4} & {SZS}_{j}^{5} & {SZS}_{j}^{6} \\ {SZS}_{j}^{7} & {SZS}_{j}^{8} & {SZS}_{j}^{9}\end{matrix} ] ,$$
wherein SZS¹ⱼ has a matrix size of rⱼ×rⱼ, SZS²ⱼ has a matrix size of rⱼ×sⱼ, SZS³ⱼ has a matrix size of rⱼ×pⱼ, SZS⁴ⱼ has a matrix size of sⱼ×rⱼ, SZS⁵ⱼ has a matrix size of sⱼ×sⱼ, SZS⁶ⱼ has a matrix size of sⱼ×pⱼ, SZS⁷ⱼ has a matrix size of pⱼ×rⱼ, SZS⁸ⱼ has a matrix size of pⱼ×sⱼ, and SZS⁹ⱼ has a matrix size of pⱼ×pⱼ.

6. The hybrid-equivalence-based power electronics system partition computing method according to claim 5, wherein the hybrid equivalent conversion comprises conversion of the hybrid excitation matrix Bⱼ, conversion of the hybrid voltage vector eⱼ, and conversion of the hybrid equivalent matrix Gⱼ, and specifically comprises the following steps:
a hybrid excitation matrix conversion formula is
$${B}_{j} = [ \begin{matrix}E & - {{SZS}_{j}^{6} ( {SZS}_{j}^{9} )}^{- 1} \\ O & - {( {SZS}_{j}^{9} )}^{- 1}\end{matrix} ] ;$$
a hybrid voltage vector conversion formula is
$${e}_{j} = [ \begin{matrix}{SZS}_{j}^{4} & {SZS}_{j}^{5} & {SZS}_{j}^{6} \\ {SZS}_{j}^{7} & {SZS}_{j}^{8} & {SZS}_{j}^{9}\end{matrix} ] [ \begin{matrix}{h}_{r j} \\ {h}_{s j} \\ {h}_{p j}\end{matrix} ] ;$$
a hybrid equivalent matrix conversion formula is
$${G}_{j} = [ \begin{matrix}{SZS}_{j}^{5} - {SZS}_{j}^{6} {( {SZS}_{j}^{9} )}^{- 1} {SZS}_{j}^{8} & {SZS}_{j}^{6} {( {SZS}_{j}^{9} )}^{- 1} \\ - {( {SZS}_{j}^{9} )}^{- 1} {SZS}_{j}^{8} & {( {SZS}_{j}^{9} )}^{- 1}\end{matrix} ] .$$

7. The hybrid-equivalence-based power electronics system partition computing method according to claim 6, wherein a structure of the coupling mapping matrix Mⱼ is
$${M}_{j} = [ \begin{matrix}{P}_{j} & O \\ O & {Q}_{j}\end{matrix} ] ,$$
wherein Pⱼ is a series interface coupling matrix corresponding to a series node, and Qⱼ is a parallel interface coupling matrix corresponding to a parallel node;
the series interface coupling matrix Pⱼ satisfies:
$${P}_{j} ( k , l ) = \{ \begin{matrix}1 & If the {k}^{th} series current of iu flows into the node l in the sub - partition j \\ - 1 & If the {k}^{th} series current of iu flows out of the node l in the sub - partition j \\ 0 & If the {k}^{th} series current of iu is not connected to the node l in the sub - partition j\end{matrix}$$
the parallel interface coupling matrix Qⱼ satisfies:
$${Q}_{j} ( k , l ) = \{ \begin{matrix}1 & If the {k}^{th} parallel voltage of iu is connected to the node l in the sub - partition j \\ 0 & If the {k}^{th} parallel voltage of iu is not connected to the node l in the sub - partition j\end{matrix} .$$

8. The hybrid-equivalence-based power electronics system partition computing method according to claim 7, wherein a formula for computing the coupling vector iu is
$$i u = - {( \sum {M}_{j} {G}_{j} {M}_{j}^{T} )}^{- 1} ( \sum {M}_{j} {B}_{j} {e}_{j} ) ,$$
wherein Mⱼ is the coupling mapping matrix; Bⱼ is the hybrid excitation matrix; eⱼ is the hybrid voltage vector; and Gⱼ is the hybrid equivalent matrix.

9. The hybrid-equivalence-based power electronics system partition computing method according to claim 8, wherein a formula for computing the node voltage in the sub-partition j is uⱼ=Zⱼ(hⱼ+Sⱼ⁻¹Mⱼ^{T}×iu).
